(19) United States
(12) Patent Application Publication
(10) Pub. No.: US 2025/0315243 A1
(43) Pub. Date: Oct. 9, 2025

(54) UPDATE OF SOFTWARE OF A VEHICLE ON THE BASIS OF VEHICLE FIELD DATA

(71) Applicant: Robert Bosch GmbH, Stuttgart (DE)

(72) Inventors: Antonia Reiter, Stuttgart (DE); Dirk Bangel, Leonberg (DE); Indrasen Raghupatruni, Hemmingen (DE); Peter Busch, Ludwigsburg (DE)

(21) Appl. No.: 18/865,597

(22) PCT Filed: May 17, 2023
(86) PCT No.: PCT/EP2023/063318

§ 371 Date: Jan. 14, 2025

(30) Foreign Application Priority Data
May 17, 2022 (DE) 10 2022 204 862.8

(51) Int. Cl. G06F 8/65; H04L 9/32

(52) U.S. Cl. CPC G06F 8/65; H04L 9/3247

(57) ABSTRACT

A computer-implemented method for a trusted update of control software of a vehicle based on vehicle field data. The method includes: receiving, in a central system, vehicle field data collected during operation of at least one vehicle and which are provided with at least one digital signature of the vehicle and/or of a user of the vehicle; including the received vehicle field data in a data corpus if the vehicle and/or the user was recognized as a valid sender of vehicle field data using the digital signature and processing the data corpus of the central system to generate training data for a machine learning model; training a machine learning model using the training data in a training environment and signing the trained machine learning model with a digital signature of the training environment; providing the trained machine learning model having the signature to another vehicle for a software update.

### BACKGROUND INFORMATION

Software (in particular control software) for vehicles is becoming increasingly complex, not least due to the increasing automation of vehicles. In addition, machine learning systems are playing an increasingly important role in vehicle software. At this point, it is desirable or even necessary to update vehicle software in the field (i.e., during operation). On the other hand, machine learning systems require training data from the field in order to ensure or improve their functionality. If the quality of the field data, the processing of the field data and/or the training of the machine learning systems leaves something to be desired, this can have significant consequences for the functionality of the software (and thus of the vehicles). It may therefore be necessary to be very restrictive regarding possible data sources of the software development cycle. On the other hand, it is desirable to integrate as many actors as possible into the process of collecting and processing field data, since a larger amount of data and data diversity often leads to better training of machine learning systems. These requirements represent a certain contradiction.

It is desirable to provide techniques that make possible a secure and efficient update of software of a vehicle on the basis of vehicle field data.

### SUMMARY

A first general aspect of the present invention relates to a computer-implemented method for a trusted update of software of a vehicle on the basis of vehicle field data. According to an example embodiment of the present invention, the method comprises receiving, in a central system, vehicle field data which were collected during the operation of at least one vehicle and which are provided with at least one digital signature of the vehicle and/or of a user of the vehicle. The method also comprises including the received vehicle field data into a data corpus if the vehicle and/or the user was recognized as a valid sender of vehicle field data by means of the relevant digital signature and processing the data corpus of the central system in order to generate training data for a machine learning model, training a machine learning model using the training data in a training environment and signing the trained machine learning model with a digital signature of the training environment. The method further comprises providing the trained machine learning model having the digital signature of the training environment to another vehicle for a software update.

A second general aspect of the present invention relates to a computer system that is designed to execute the method according to the first general aspect of the present invention.

The techniques of the first and second general aspects can have one or more of the following advantages.

First, by adding digital signatures to data at various points in a software development cycle, the origin of the data can be verified. In particular, this can take place automatically. In some cases, this can ensure that vehicle field data, trained machine learning models or software updates for vehicles come from trusted sources. This can ultimately ensure and/or improve the performance of vehicles supplied with software updates (in particular at least partially autonomous vehicles).

Secondly, digital signatures (which in some examples are generated with a decentrally generated key) can achieve scalability and extensibility to different sources of data (e.g., drivers or organizations).

Some terms are used in the present disclosure in the following way:

The term “vehicle” includes any device that transports passengers and/or cargo. A vehicle can be a motor vehicle (for example a passenger car or a truck), but also a rail vehicle. However, floating and flying devices can also be vehicles.

The term “user” includes any person who drives, is transported by, or supervises the operation of the vehicle. A user can be a passenger of a vehicle (in particular a driver). However, a user can also be outside the vehicle and, for example, control and/or monitor it (e.g., during a parking maneuver or from a remote control center).

A “digital signature” in the present disclosure is part of an asymmetric encryption system in which a sender uses secret information (e.g., a secret signature key, also referred to as a secret key or private key) to calculate a data item, called a signature, for any data (in the present disclosure, e.g., vehicle field data, machine learning models or software updates). This data item enables third parties to verify the authorship and/or integrity of any data by using public information (e.g., a verification key, also called a public key). In order to be able to assign to an author a signature created by means of a signature key, the corresponding verification key must be unambiguously assigned to this person. A digital signature can therefore verifiably identify the author of the data.

“Vehicle field data” (or simply “field data”) include all data that arise in connection with the operation of one (or of a large number of) vehicles and that are used in particular for the design (e.g., training) of vehicles or their systems. For example, vehicle field data can be used to generate corresponding operating scenarios in a simulation environment for training vehicles (or the systems they contain). “Vehicle field data” are a corpus of field data. In some cases, the vehicle field data may contain the field data in a form structured according to a single predefined schema. However, the corpus of vehicle field data can consist of different data sub-sets, each of which is structured differently.

A “cloud computing system” is an infrastructure that is made available via a network, for example via the Internet. A “cloud computing system” typically includes storage space, processing power, and/or application software as a service (i.e., a user can access these resources via the network). In other words, a “cloud computing system” is an infrastructure that is made available via a network, without having to be present/installed on the local system. “Cloud computing systems” can contain distributed resources (for example, a plurality of computer systems at different locations). The resources of the “cloud computing system” are offered and used via technical interfaces and protocols, for example by means of a web browser.

### BRIEF DESCRIPTION OF THE DRAWINGS

FIG. 1 shows an exemplary system according to the present invention.

FIG. 2 is a flowchart of the steps of the techniques of an example embodiment of the present invention.

FIG. 3 illustrates the issuing and verification of digital signatures of the present invention.

### DETAILED DESCRIPTION OF EXAMPLE EMBODIMENTS

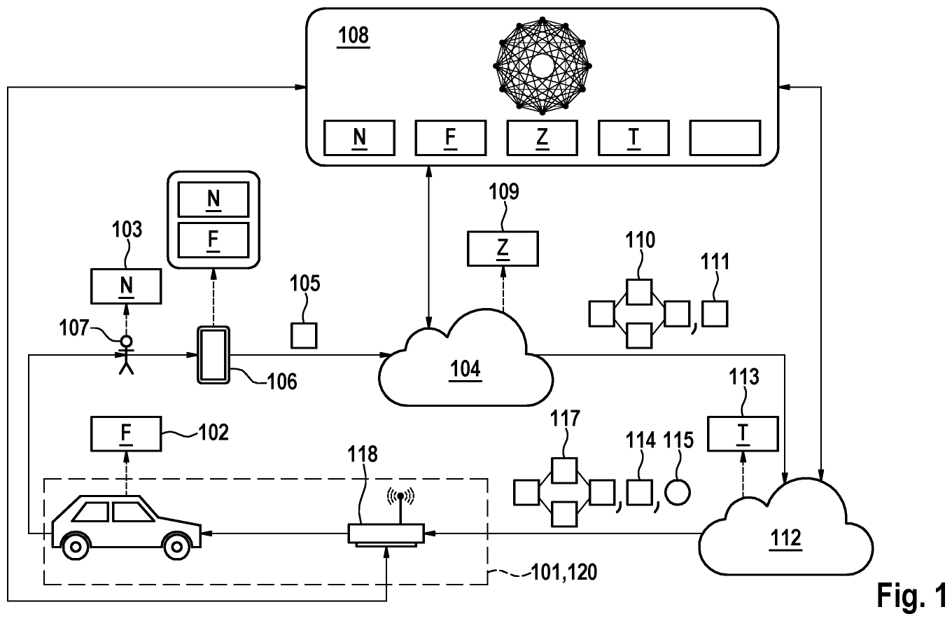

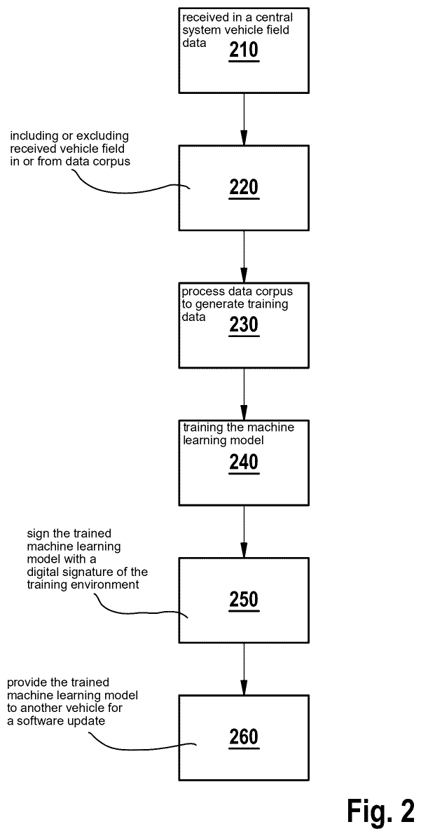

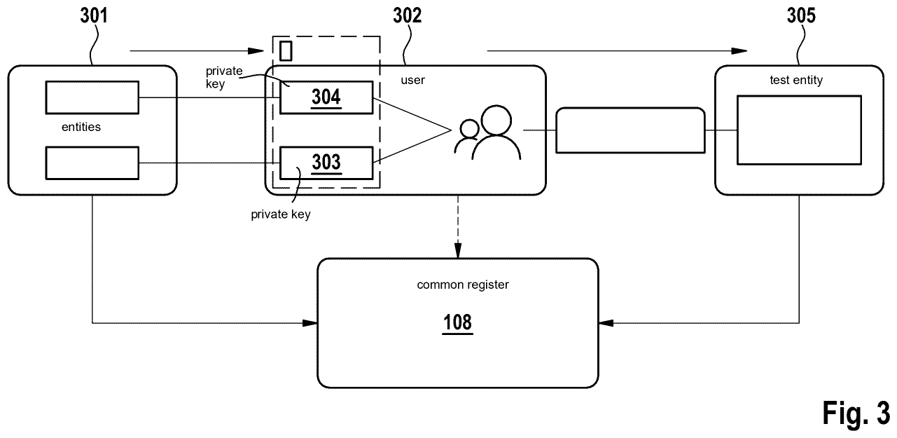

Firstly, the techniques of the present disclosure are explained with the aid of FIG. 1 and FIG. 2. Further aspects of the digital signatures of the present disclosure (e.g., generated by means of decentrally generated keys) are discussed below with the aid of FIG. 3.

FIG. 1 shows an exemplary system according to the present disclosure. FIG. 2 is a flowchart of the steps of the techniques of the present disclosure.

The method comprises receiving 210, in a central system 104, vehicle field data 105 which were collected during the operation of at least one vehicle 101 and which are provided with at least one digital signature of the vehicle 102 and/or of a user of the vehicle 103 (e.g., a driver 107 of the vehicle 101). In some examples, receiving vehicle field data 105 may be via an air interface (e.g., via a cellular channel).

Vehicle field data 105 may include sensor data collected during operation of the vehicle 101. The vehicle field data 105 may, for example, be present as time series data. The vehicle field data 105 may include image data (e.g., single image or video image data).

The sensor data may include, for example, camera data (e.g., in the visible or infrared spectral range), lidar sensor data, radar sensor data, temperature sensor data and/or ultrasonic sensor data. Alternatively or additionally, the sensor data may be position data (e.g., GPS data) or vehicle field data that describe an operating state of the vehicle (e.g., steering angle, speed, operating mode, load, etc.). The sensor data can characterize the vehicle's environment, its interior and/or its operating state. It is possible for the corresponding sensors that generate the sensor data to be located within the vehicle (i.e., moving with and by means of the vehicle). In other examples, the sensors can also be located outside the vehicle (e.g., in infrastructure components or in other vehicles or road users).

In an illustrative example, the sensor data may be camera data from a camera of an autonomous vehicle (e.g., a camera facing the direction of travel). These camera data are processed continuously (for example, to create an environment model of the autonomous vehicle).

The method also comprises including 220 the received vehicle field data 105 in a data corpus if the vehicle 101 and/or the user 107 of the vehicle was recognized as a valid sender of vehicle field data 105 by means of the relevant digital signature 102, 103. On the other hand, the received vehicle field data 105 cannot be included in the data corpus if the vehicle 101 and/or the user 107 was not recognized as a valid sender of vehicle field data 105 by means of the digital signature 102, 103. In other examples, the central system 104 may in this case request additional information from the sender of the vehicle field data 105.

Public keys for the digital signatures of the vehicle 102 and/or of a user of the vehicle 103 (e.g., a driver of the vehicle 101) can be stored in a common register 108.

Checking the digital signatures of the vehicle 102 and/or of a user of the vehicle 103 may include querying a public key of the relevant signature 102, 103 in the common register 108. In some examples, a sender of the vehicle field data 105 may be considered a valid sender if the digital signature 102, 103 can be verified with the aid of the relevant public key from the common register 108. If no public key is stored in the common register 108 for a digital signature 102, 103 and/or a digital signature of the vehicle 102 and/or of the user of the vehicle 103 cannot be verified using the relevant public key, a sender of the vehicle field data 105 cannot be considered a valid sender.

The digital signatures of the vehicle 102 and/or of the user of the vehicle 103 (and also the other digital signatures of the present disclosure) may be digital signatures generated with a decentrally generated key. Additional aspects of the decentrally generated keys and of the digital signatures generated therewith are discussed below in connection with FIG. 3.

In some examples, the central system 104 may be a first cloud computing system. In some examples, the first cloud computing system may include cloud storage to receive the vehicle field data 105 and store the data corpus.

The vehicle field data 105 can be filtered and/or preprocessed.

The method further comprises processing 230 the data corpus of the central system 104 in order to generate training data for a machine learning model.

The steps of generating training data may, in some examples, include one or more of the following steps.

The vehicle field data 105 can be put into a machine-readable format (e.g., into an input format for a training environment for a machine learning model). Alternatively or additionally, certain information can be extracted from the vehicle field data 105 (e.g., still image data or sequences of image data and/or position data), which information is then further processed. Further alternatively or additionally, the vehicle field data 105 (or information extracted therefrom) can be provided with labels 111 (e.g., to make possible the training of a machine learning model, e.g., of a classifier).

The techniques of the present disclosure further include training 240 a machine learning model using the training data in a training environment. In the example in FIG. 1, the training environment is part of the central system 104. In other examples, the training environment may be located in another system (e.g., another cloud computing system or another system networked with the other systems of the present disclosure).

The machine learning model can be a classifier. In some examples, the classifier may be an image classifier (e.g., for detecting objects in the environment or inside the vehicle and/or for classifying operating states of the vehicle and/or of its environment). An image classifier can classify, on the basis of features of image data (e.g., pixel values, position of edges, etc.), images or objects contained therein (e.g., in order to detect certain objects in the vehicle's environment). In other examples, the classifier may process other data types and/or provide other classification results (e.g., regarding an operating state of the vehicle and/or a state of the vehicle's environment). In still other examples, the machine learning model may be a regressor or another type of model.

The machine learning model can include one or more neural networks. The method further comprises signing 250 the trained machine learning model 110 with a digital signature of the training environment 109. If the training environment is part of the central system 104 (e.g., part of a first cloud computing system), the digital signature of the training environment 109 may be a digital signature of the central system 104.

The methods according to the present disclosure further include providing 260 the trained machine learning model 110 having the signature of the training environment 109 to another vehicle 120 for a software update. In some examples, labels 111 of the training data used to train the machine learning model may also be provided.

The methods of the present disclosure may include additional steps.

In some examples, a method for a trusted update of software of a vehicle includes receiving, in a software test environment 112, the trained machine learning model 110 having the signature of the training environment 109. In the software test environment 112, the digital signature of the training environment 109 (e.g., the central system) can be checked. In a further step, the trained machine learning model can be tested in the software test environment 112 if, on the basis of the digital signature of the training environment 109 (e.g., the central system), the training environment 104 was recognized as a valid sender of a trained machine learning model.

In some examples, the software test environment is located in a second cloud computing system. The second cloud computing system may be different from the first cloud computing system (in which the central system and/or the training environment are located) (e.g., the first cloud computing system and the second cloud computing system may be managed by different entities).

Checking the digital signature of the training environment 109 (e.g., of the central system) may include querying a public key of the digital signature of the training environment 109 in the common register 108. In some examples, a training environment 104 may be considered a valid sender if the digital signature of the training environment 109 can be verified using a key stored in the common register 108. If no corresponding key is stored in the common register 108 or if the digital signature of the training environment 109 cannot be verified using the stored public key, a training environment 104 cannot be considered a valid sender.

In some examples, the trained machine learning model 110 may be integrated into a simulation environment in the software test environment 112.

In the simulation environment or another test environment of the software test environment 112, the trained machine learning model 110 can be tested (e.g., tested for a specified functionality).

In some examples, the trained machine learning model 110 together with an associated software component of a vehicle may be tested in the software test environment 112.

The method may also include signing the tested machine learning model 117 with a digital signature of the software test environment 113 (e.g., if a specified functionality was recognized in the software test environment 112). The method may also include providing the tested machine learning model 117 having the digital signature of the software test environment 113 to a control unit (not shown in FIG. 1) of the other vehicle 120 in a software update. In some examples, in addition to the tested machine learning model 117 (or alternatively), a software component 116 of a vehicle may be provided as part of the software update. Additionally or alternatively, the labels 111 may be provided as part of the software update. The additional (or alternative) data may likewise be provided with the digital signature of the software test environment 113.

In some examples, the method may include receiving, in a vehicle 101, 120 (e.g., the other vehicle 120), the software update with a digital signature of the software test environment 112 and/or with the digital signature of the training environment 109. In the relevant vehicle 101, 120, the digital signature of the software test environment 112 and/or the digital signature of the training environment 109 can be used to check whether the software test environment 112 and/or the training environment 109 are valid senders of software updates.

Checking the digital signature of the software test environment and/or the digital signature of the training environment 109 may include querying a public key of the relevant digital signature in the common register 108.

In some examples, a training environment 104 may be considered a valid sender if the signature can be verified using a public key from the common register 108. If, however, no public key for a training environment is stored in the common register 108 and/or the digital signature of the training environment 109 cannot be verified by means of a stored public key, a training environment 104 cannot be considered a valid sender.

Similarly, a software test environment 112 may be considered a valid sender if the signature can be verified using a public key from the common register 108. However, if no public key for a software test environment is stored in the common register 108 and/or the digital signature of the software test environment cannot be verified by means of a stored public key, a software test environment cannot be considered a valid sender.

In some examples, receiving the software update and/or checking the digital signature of the software test environment 112 and/or a digital signature of the training environment 109 may be performed by a connectivity module 116 of the vehicle 101, 120.

If the software test environment 112 and/or the training environment 104 are recognized as valid senders of software updates, updating of a software component of the vehicle can take place in the vehicle 101, 120 using the software update. If the software test environment 112 and/or the training environment 104 are not recognized as valid senders of software updates, the vehicle 101, 120 may prevent the updating of a software component of the vehicle using the software update.

The software update can be provided to the vehicle 101, 120 via an air interface.

In the procedures described above, providing different data with respective digital signatures can make it possible for the various systems involved to check the relevant sender as a valid data source. The testing steps can be carried out automatically (i.e., without user intervention). In some cases, this can improve not only the security but also the efficiency of the development process of software components for vehicles (in particular for at least partially autonomous vehicles). In addition (and as a consequence), the methods of the present disclosure can be more easily scalable because the ability of the data sources to be validated also allows other data sources than in related art methods to be integrated into the development process of the software components. This in turn can lead to a broader database being made available for the development of software components, which can increase the quality of software components based on machine learning.

In FIG. 1, a single training environment and a single software test environment 112 are shown. In other examples, the system of the present disclosure may include multiple training environments and multiple software test environments that exchange data using respective digital signatures.

In some examples, the data corpus of the central system 104 may be processed to generate second training data for a second machine learning model. A second machine learning model may be trained using the second training data in a second training environment, and the trained second machine learning model may be provided with a digital signature of the second training environment.

The steps described above with respect to generating training data and training the machine learning model can be equally applied to generating the second training data and the second machine learning model.

The first training environment and the second training environment can be located on different cloud computing systems. The first training environment and the second training environment can train machine learning models for different purposes. The different purposes can be one or more of different vehicle types and/or different control unit types and/or different control software. The second machine learning model trained in the second training environment can, as described above, be sent to the software test environment 112 and/or to a vehicle 101, 120 and further processed there.

In some examples, the system may include one or more additional training environments that, like the first/second training environment, can train machine learning models.

In some examples, the system includes a second software test environment.

The second software test environment can receive the trained machine learning model 110 (and possibly label 111) having the digital signature of the training environment 109. In the second software test environment, the trained machine learning model 110 can be tested if the training environment was recognized as a valid sender of a trained machine learning model on the basis of the digital signature of the training environment 109. In addition, in the second software test environment, the tested machine learning model can be signed with a digital signature of the second software test environment. The tested second machine learning model can be provided with the digital signature of the second software test environment to a control unit of another vehicle 120 as part of a software update.

In some examples, a software component of a vehicle may be provided as part of the software update in addition to the second machine learning model tested. Additionally or alternatively, the labels can be provided as part of the software update. The additional data may also be provided with the digital signature of the second software test environment.

The first and second software test environments can train software components for different purposes. The different purposes can be one or more of different vehicle types and/or different control unit types and/or different control software.

The first software test environment 112 and the second software test environment may be located on different cloud computing systems.

In some examples, the system may include one or more additional software test environments that, like the first/second software test environments, can test machine learning models and software components of a vehicle.

In some examples, the vehicle field data 105 may be sent from a vehicle 101. For this purpose, the vehicle field data 105 can be signed with at least one digital signature of the vehicle 102 and/or of the user of the vehicle 103 and the signed vehicle field data can be sent to the central system 104. The digital signature of the vehicle 101 can be applied by the vehicle 101 itself or by the user 107. In some examples, a mobile device 106 (e.g., a smartphone) of the user 107 can be used to sign the vehicle field data 105. In other examples, a component of the vehicle (not shown in FIG. 1) can perform the signing with the digital signature of the vehicle 102.

In some examples, sending of the signed vehicle field data 105 can be triggered via the mobile device 106. In other examples, sending of the signed vehicle field data 105 can be triggered via a user interface of the vehicle 101, 120.

In the preceding examples, the techniques of the present disclosure were explained using two vehicles. In some examples, vehicle field data may be collected from a fleet of vehicles (e.g., more than 100 vehicles or more than 10,000 vehicles) using the techniques of the present disclosure and/or software components of a fleet of vehicles (e.g., more than 100 vehicles or more than 10,000 vehicles) may be updated using the techniques of the present disclosure.

In the above examples, digital signatures of a vehicle, a user of the vehicle, a training environment and/or a software test environment were applied and verified at various points in a software development cycle. In other examples, this sequence can also be varied. This means that the digital signatures of vehicle field data (e.g., of vehicles and/or users) can also be verified at other locations (e.g., in a software test environment or in a vehicle). In other examples, additional digital signatures may be used in addition to the digital signatures discussed above.

FIG. 3 illustrates the issuing and use of digital signatures of the present disclosure.

As mentioned above, the digital signatures of the present disclosure may be decentrally generated digital signatures. Each participating system (or at least a plurality of the participating systems) can in this case independently issue information for generating digital signatures (i.e., there is no central authority that issues information for generating all digital signatures used in the present disclosure). For example, signature keys of the digital signature of the vehicle and/or the user and/or the digital signature(s) of the training environment(s) and/or the digital signature(s) of the software test environment(s) (or other information for generating digital signatures) may be generated by at least two different entities. In particular, signature keys (or other information for generating digital signatures) of the digital signatures of different training environments may be generated by different entities. Additionally or alternatively, signature keys (or other information for generating digital signatures) of the digital signatures of different software test environments may be generated by different entities. In still other examples, signature keys of the signatures of different vehicles may be generated by different entities (e.g., by different organizations that operate and/or manufacture the respective vehicles).

On the left-hand side in FIG. 3 entities 301 are shown which issue signature keys for the digital signatures of the present disclosure. This may include generating a key pair containing a private key and a relevant public key. The public key can be stored in the common register 108. The private key is provided to the relevant user 302 of the key. In FIG. 3, as an example, a user of a vehicle is shown who receives a private key 303 for the signature of the vehicle from a first entity and the private key 304 for the signature of the user from a second entity. The user can store the private keys in a suitable device (e.g., a mobile device).

Keys for the other digital signatures of the present disclosure (in particular the training environment(s) and the software test environment(s)) may be generated in a similar manner.

Signing data by means of the signature can be done using the relevant private key 303, 304. For example, the user 302 may affix a digital signature of the user using the private key 304 for the signature of the user (and likewise the other systems of the present disclosure that affix digital signatures).

The data signed in this way can be validated by a test entity 305 (e.g., the central network, the software test environment and/or a vehicle). For this purpose, a public key of the relevant signer can be queried in the common register 108. If the digital signature can be verified using the public key, it and therefore the signed data can be considered valid.

The present disclosure also relates to a computer system that is designed to perform the methods according to the present disclosure. As already described, the computer system may comprise a large number of distributed nodes connected to one or more networks (e.g., the Internet). The individual nodes can in turn contain cloud computing systems.

In one example, the computer system includes a first cloud computing system that is designed to perform the steps of receiving vehicle field data, including the received vehicle field data in a data corpus, processing the data corpus, training a machine learning model, and signing the trained machine learning model.

Additionally or alternatively, the computer system comprises a second cloud computing system that is designed to perform the steps of checking the digital signature of the training environment, testing the trained machine learning model and signing the validated machine learning model and/or an associated software component and providing the tested machine learning model and/or an associated software component to a control unit of another vehicle.

As discussed above, the computer system may further comprise a common register in which the public keys for the digital signatures according to the present disclosure are stored. In some examples, the common register 108 may use a blockchain method to store the public keys of the present disclosure. In this case, multiple versions of the common register may exist. For example, the common register 108 may be a multiply replicated register stored in different locations, the different replicas of the register 108 being synchronized (i.e., in the form of a “distributed ledger”). For example, the various replicas of the common register (108) may be stored in and/or managed by at least some of the systems described herein (i.e., not by a single central entity).

In some examples, the computer system further includes an on-board system of at least one vehicle (or on-board systems of a fleet of vehicles), said on-board system or systems being designed to perform the steps of receiving the software update, checking whether the software test environment and/or the training environment are valid sources of software updates, and updating a software component of the vehicle using the software update.

In some examples, the computer system further comprises a mobile device that is designed to provide the vehicle field data with the at least one digital signature of a vehicle and/or user of the vehicle. The mobile device can further be designed to send the vehicle field data to the central system.

The present disclosure also relates to a computer program that performs the steps of one of the methods of the present disclosure.

The present disclosure also relates to a computer-readable medium or signal that stores or contains a computer program of the present disclosure.

1-12. (canceled)

13. A computer-implemented method for a trusted update of software of a vehicle based on vehicle field data, the method comprising the following steps:
receiving, in a central system, vehicle field data which were collected during operation of at least one vehicle and which are provided with at least one digital signature of the vehicle and/or of a user of the vehicle;
including the received vehicle field data in a data corpus based on the vehicle and/or the user being recognized as a valid sender of vehicle field data using the digital signature of the vehicle and/or of the user of the vehicle;
processing the data corpus of the central system to generate training data for a machine learning model;
training a machine learning model using the training data in a training environment;
signing the trained machine learning model with a digital signature of the training environment; and
providing the trained machine learning model having the signature of the training environment to another vehicle for a software update.

14. The method according to claim 13, wherein the providing of the trained machine learning system includes:
checking the digital signature of the central system in a software test environment;
testing the trained machine learning model and/or a software component in the software test environment based on the training environment being recognized as a valid sender of a trained machine learning model based on the digital signature of the central system;
signing the tested machine learning model and/or the tested software component with a digital signature of the software test environment;
providing the tested machine learning model and/or the tested software component having the digital signature of the software test environment to a control unit of the other vehicle in the software update.

15. The method according to claim 13, wherein the digital signatures: (i) of the vehicle and/or of the user, and (ii) of the training environment, are generated using decentrally generated keys.

16. The method according to claim 14, wherein keys: (i) of the digital signature of the vehicle and/or of the user, and/or (ii) of the digital signature of the training environment. and/or (iii) of the digital signature of the software test environment, are generated by at least two different entities.

17. The method according to claim 13, wherein public keys for the digital signatures: (i) of the vehicle and/or of the user, and (ii) of the training environment, are stored in a common register.

18. The method according to claim 14, wherein the checking of the digital signature of the central system includes querying a public key of the digital signature of the central system in a common register.

19. The method according to claim 13, wherein the central system is a first cloud computing system.

20. The method according to claim 14, further comprising:
checking the digital signature of the central system in a second software test environment;
testing the trained machine learning model and/or a second software component in a second software test environment based on the central system being recognized as a valid sender of a trained machine learning model based on the digital signature of the central system;
signing the tested second machine learning model and/or the second software component with a digital signature of the second software test environment; and
providing the tested second trained machine learning model and/or the second software component having the digital signature of the second software test environment to a control unit of another vehicle.

21. The method according to claim 13, wherein the software update is provided to the vehicle via an air interface.

22. The method according to claim 14, further comprising:
receiving the software update with a digital signature of the software test environment and/or with a digital signature of the training environment;
checking whether the software test environment and/or the training environment are valid senders of software updates; and
updating a software component of the other vehicle using the software update.

23. The method according to claim 13, further comprising:
signing the vehicle field data by the user of the vehicle with the at least one digital signature of the vehicle and/or of the user; and
sending the signed vehicle field data to the central system.

24. A computer system for a trusted update of software of a vehicle based on vehicle field data, the computer system being configured to perform the following steps:
receiving, in a central system, vehicle field data which were collected during operation of at least one vehicle and which are provided with at least one digital signature of the vehicle and/or of a user of the vehicle;
including the received vehicle field data in a data corpus based on the vehicle and/or the user being recognized as a valid sender of vehicle field data using the digital signature of the vehicle and/or of the user of the vehicle;
processing the data corpus of the central system to generate training data for a machine learning model;
training a machine learning model using the training data in a training environment;
signing the trained machine learning model with a digital signature of the training environment; and
providing the trained machine learning model having the signature of the training environment to another vehicle for a software update.
